(19) United States
(12) Patent Application Publication
(10) Pub. No.: US 2015/0166810 A1
(43) Pub. Date: Jun. 18, 2015

(54) Metal Nanoparticle Synthesis and Conductive Ink Formulation

(71) Applicant: Nano and Advanced Materials Institute Limited, Shatin, New Territories, Hong Kong (CN)

(72) Inventors: Li FU, Hong Kong (CN); Kai LI, Hong Kong (CN); Chau Shek LI, Hong Kong (CN)

(21) Appl. No.: 14/515,539

(22) Filed: Oct. 16, 2014

Related U.S. Application Data
(60) Provisional application No. 61/963,847, filed on Dec. 16, 2013.

(51) Int. Cl. C09D 11/52; H01B 1/02; H01B 13/00; B22F 9/24

(52) U.S. Cl. CPC C09D 11/52; B22F 9/24; H01B 1/02; H01B 13/00

(57) ABSTRACT

A conductive ink formuation comprising metal nanoparticles and the preparation of the metal nanoparticles therein are disclosed. The ink formulation comprises at least one type of metal nanoparticles and solvent, which is to adjust the viscosity and surface tension of the ink formulation as well as the aggregation of the metal nanoparticles. The ink formulation is stable and demonstrates optimal performance, such as, improved jetting performance and good wetting property. The ink formulatin can be printed on a substrate and be further processed by sintering. The resultant film is of high conductivity. Since the annealing temperature in the present invention is relatively low, the fabrication process is compatible with plastic substrate used for flexible electronics.

### CROSS-REFERENCE TO RELATED APPLICATION

This application claims benefit under 35 U.S.C. §119(e) of U.S. Provisional Application having Ser. No. 61/963,847 filed on Dec. 16, 2013, which is hereby incorporated by reference herein in its entirety.

### FIELD OF INVENTION

This invention relates to an inkjet ink formulation, and in particular an ink formulation with metal nanoparticles.

### BACKGROUND OF INVENTION

Metal nanoparticles and its related ink have attracted broad interest in printed electronics industry due to their unique properties related with the reduced size and increased surface area. More recently, metal nanoparticle inks has been used to directly print fine conductive patterns with inkjet printing method. This particular method requires that the ink contains high concentration of small nanoparticles which can be well dispersed in solvents. Even though there are lots of research in this area, the synthesis process of metal nanoparticles and the stability of the formulated still have room for improvement. The printed film requires sintering at higher temperature to achieve good conductivity of the printed patterns. It is desirable to have low sintering temperature so that the device fabrication process is compatible with plastic substrate used for many flexible electronics.

### SUMMARY OF INVENTION

In the light of the foregoing background, it is an object of the present invention to provide an improved metal nanoparticle synthesis method and an ink formulation with high solid material loading and to be stable over its shelf life as well as to be able to form ink formulation with good conductivity after low temperature annealing.

Accordingly, the present invention, in one aspect, provides an ink formulation, comprising metal nanoparticles in the range of 10%-40% by weight-volume percentage of said ink formulation; a dispersant in the range of 0.5%-5% by weight percentage of said ink formulation; a viscosity modifying solvent in the range of 15%-50% by weight percentage of said ink formulation; and a surface tension adjusting solvent in the range of 30%-80% by weight percentage of said ink formulation.

In one exemplary embodiment of the present invention, the size of the metal nanoparticles is 20-30 nanometers.

In one exemplary embodiment of the present invention, the viscosity of the ink composition is between 3-30 cPs, or 3-20 cPs.

In another aspect, the present invention discloses a method of forming a metal nanoparticle mixture, comprising

a) dissolving PVP in glycol based solvent to obtain PVP solution;

b) dissolving metal precursor into a hydrophilic solvent to prepare metal salt solution;

c) adding said metal salt solution in step b) into said PVP solution in step a) with controlled speed to formulate a mixture; and

d) centrifuging said mixture in step c) and further washing to obtain said metal nanoparticle.

In one exemplary embodiment of the present invention, the size of said metal nanoparticles is in the range of 20-30 nanometers.

In one exemplary embodiment of the present invention, a reducing agent is further introduced before the above step c) into the PVP solution in the above step a).

In a further aspect, the present invention provides a method of fabricating a conductive film comprsing

a) forming an ink formulation of claim 1;

b) filtering said ink formulation in step a) and loading the filtered ink into a printer;

c) forming a film by printing said filtered ink on a substrate by pre-set printing parameters; and

d) sintering said film in step c) to obtain said conductive film;

wherein the sintering is conducted at a temperature not higher than 150° C.

In one exemplary embodiment of the present invention, the resistivity of said conductive film is less than 15 μΩ·cm, or less than 12 μΩ·cm.

One of the advantages of the present invention is the high stability of the ink formulation. Another advantage of the present invention is that the wetting property and jetting performance of the ink formuation have been improved while the loading of the metal nanoparticles can be maintained at a high concentration. In addition, according to the present invention, a film with good conductivity can be formed at a lower sintering temperature.

### BRIEF DESCRIPTION OF FIGURES

FIG. 1 shows TEM image of Ag nanoparticle synthesized in example 1 of the invention.

FIG. 2 shows SEM image of Cu nanoparticles synthesized in example 2 of the invention.

FIG. 3(a) shows SEM image of a deposited film comprising Ag nanoparticle; FIG. 3(b) shows SEM image of the film after annealing at 150° C. for 30 min.

### DETAILED DESCRIPTION OF THE PREFERRED EMBODIMENTS

As used herein and in the claims, “comprising” means including the following elements but not excluding others.

Fluent drop formation refers to the relatively constant drop velocity of the ink from the nozzle while the drop shape is ideally tear-shaped sphere without tail. The drop flows along the co-axial of the nozzle without tilting.

### Synthesis and Analysis of a Metal Nanoparticle Mixture

The present invention provides a facile method to synthesis metal nanoparticles that can be dispersed in aqueous solvents:

1. Dissolve polyvinvylpyrrolidone (PVP) in ethylene glycol (EG) or diethylene glycol (DEG) by heating up to 90-160° C. with mechanical agitation.

2. Add reducing agent to the above PVP solution if it is required. The need of reducing agent and its concentration will depends on the metal salt used.

3. Dissolve metal precursor into DI water or EG solution.

4. Add metal salt solution into PVP solution with controlled speed.

5. Separate metal nanoparticles from solution by centrifugation after the reactions are completed.

6. Purify the nanoparticles by washing with acetone/alchol solvents and separate by centrifugation.

The images of the metal nanoparticles are captured by TEM or SEM. The size of the metal nanoparticles is in the range of 20 nm-30 nm.

### Synthesis of Ink Formulation

The present invention provides a method to prepare ink formulation comprising at least one metal nanoparticles:

1. The as-washed metallic nanoparticles and solvent are mixed thoroughly by a mild energy mixer such as planetary ultrasonic mixer until well combined, to form wet slurry.

2. A pre-mixed stable solvent is also formulated by mixing proper weight part of dispersant, solvent etc., through a general mechanical agitator or ultrasonic mixer.

3. The metal nanoparticles slurry and pre-mixed solvent are weighed according to suitable weight ratio, and then they are mixed and formulated into ink through dispersion process that combines medium/high energy mixer and mechanical agitation.

4. The resulted ink is filtered through a 0.45 micron filter, such as those manufactured by Millipore, USA. It is loaded into a piezo-electrical inkjet printer cartridge and serial printing parameters are adjusted, until stable formation and jetting of ink drop.

The ink formulation is further filtered and loaded into a printer. The desired patterns can be obtained by proper programming the printing parameters.

### Composition of the Ink Formulation

The ink formulation should contain at least one metal nanoparticle contributing to the conductivity of the ink formulation.

The ink formulation can contain a dispersant functionalized with specific groups having affinity to nanoparticles, in order to facilitate nanoparticles dispersion and prevent agglomeration for stable jetting.

One or more viscosity modifying solvent can be added in the ink to adust the viscosity of the ink formulation to a range for smooth printing.

The surface tension can be tuned until fluent drop formation from the printer to improve jetting performance and wetting property of the ink formulation.

### Example 1

### Synthesis of Silver Nanoparticle

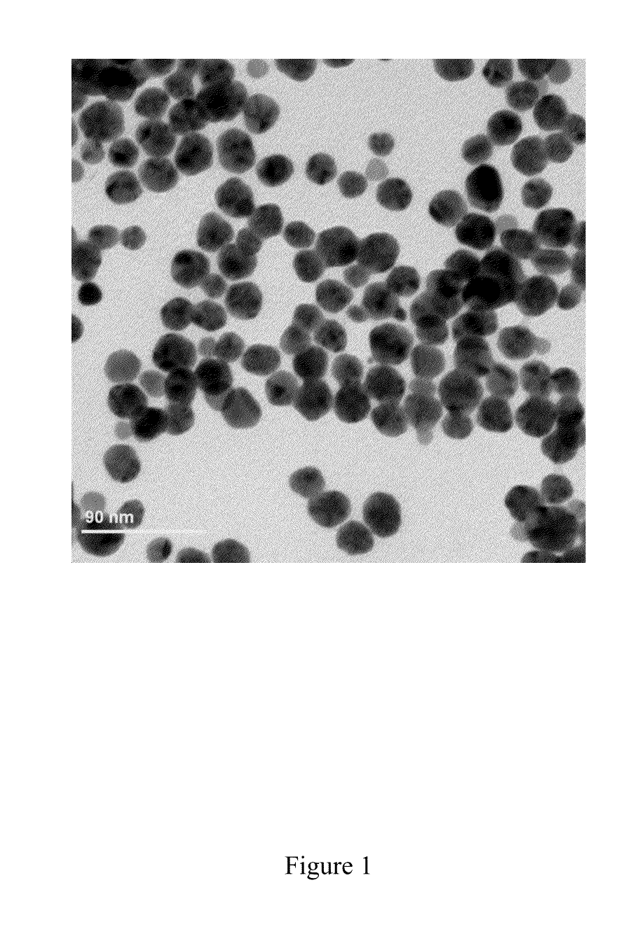

36.4 g of polyvinvylpyrrolidone (Mw: 10000) was dissolved into 75 mL of ethylene glycol with magnetic stirring while heated to 120° C. 5.8 g of silver nitrate was dissolved into 25 mL of ethylene glycol. The silver nitrate solution was added into PVP solution and the reaction mixture was stirred for 1 hour before cooling down to room temperature. After completion of the reaction, the mixture was centrifuged out at 10000 rpm and washed with ethanol and acetone. The purified silver nanoparticles were not dried, but kept in ethanol environment for subsequent ink formulation. Please refer to FIG. 1 for the TEM image of Ag nanoparticles as synthesized.

### Example 2

### Synthesis of Copper Nanoparticle

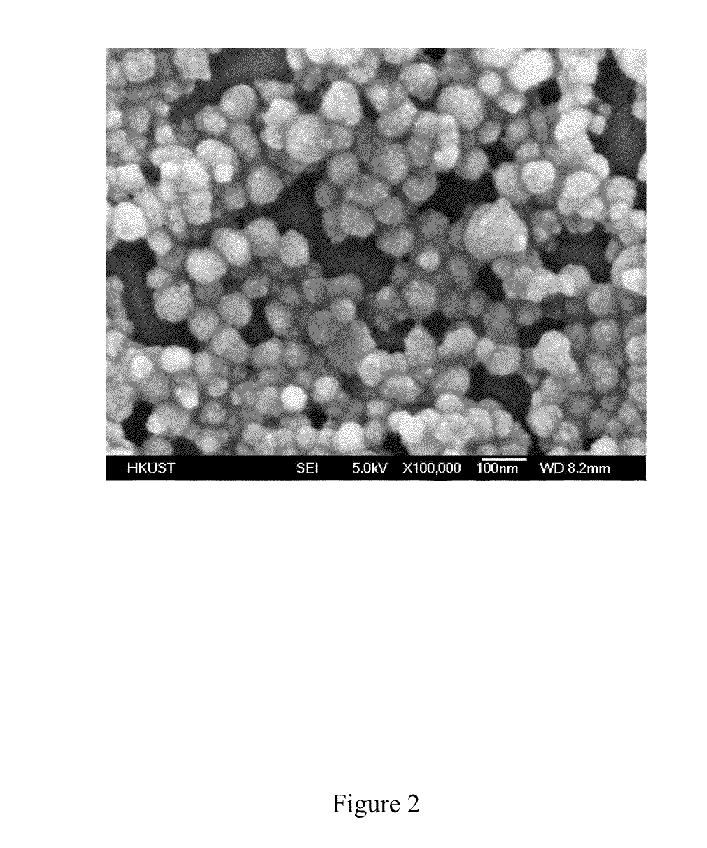

37 g PVP (Mw: 40000) and 1.1 g sodium hypophosphate (NaH2PO2) was dissolved into 100 ml of diethylene glycol (DEG) with magnetic stirring while heated to 140° C. 1.6 g copper sulfate (CuSO4) was dissolved into 10 ml DI water or EG. The copper sulfate solution was injected into the PVP solution with a controlled speed of 10 ml/min and the reaction mixture was stirred for 1 hour. After completion of the reaction, the mixture was centrifuged out at 10000 rpm and washed with ethanol and acetone. The purified copper nanoparticles were not dried, but kept in ethanol environment for subsequent ink formulation. Please refer to FIG. 2 for the SEM image of Cu nanoparticles as synthesized.

### Example 3

### Preparation of Silver Nanoparticle Ink Formulation

Mix 5 mL of H2O, 2.5 mL of EG, 2 mL of IPA, 0.5 mL of glycerol and 0.1 g of DISPERBYK-190 into a 20-mL glass vial and mix the solutions with vortex. Add 3.1 g of silver nanoparticle from example 1 into the solution mixture. Disperse the nanoparticles through mechanical stirring in an ultrasonic bath for >3 hours. 10 ml of ink with solid loading of ˜3 g/10 ml can be obtained at the end. The resultant ink formulation can be stable for at least 3-6 months. The jetting performance and wetting property thereof have been improved. The ink can drop at a relatively constant velocity from the nozzle while the drop shape is tear-shaped sphere without tail. The drop flows along the co-axial of the nozzle without tilting.

### Example 4

### Preparation of Copper Nanoparticle Ink Formulation

Mix 5 mL of H2O, 2.5 mL of EG, 2 mL of IPA, 0.5 mL of glycerol and 0.1 g of DISPERBYK-190 into a 20-mL glass vial and mix the solutions with vortex. Add 1.5 g of copper nanoparticle from example 2 into the solution mixture. Disperse the nanoparticles through mechanical stirring in an ultrasonic bath for >3 hours. 10 ml of ink with solid loading of ˜1.5 g/10 ml can be obtained at the end. The resultant ink formulation can be stable for at least 3-6 months. The jetting performance and wetting property thereof have been improved. The ink can drop at a relatively constant velocity from the nozzle while the drop shape is tear-shaped sphere without tail. The drop flows along the co-axial of the nozzle without tilting.

### Example 5

### Preparation of Silver-Copper Nanoparticle Ink Formulation

Mix 5 mL of H2O, 2.5 mL of EG, 2 mL of IPA, 0.5 mL of glycerol and 0.1 g of DISPERBYK-190 into a 20-mL glass vial and mix the solutions with vortex. Add 1.5 g of copper nanoparticle and 1 g of silver nanoparticle into the solution mixture. Disperse the nanoparticles through mechanical stirring in an ultrasonic bath for >3 hours. 10 ml of ink with solid loading of ˜2.5 g/10 ml can be obtained at the end. The resultant ink formulation can be stable for at least 3-6 months. The jetting performance and wetting property thereof have been improved. The ink can drop at a relatively constant velocity from the nozzle while the drop shape is tear-shaped sphere without tail. The drop flows along the co-axial of the nozzle without tilting.

### Example 6

### Preparation of Printed Film and Post Sintering Process

The ink formulation is filtered and loaded into a printer. The desired patterns can be obtained by proper programming the printing parameters.

The printed patterns can be electrically conductive shortly after sintered. Apattern with size of 3 mm×5 mm with film thickness of 900 nm has been printed with the ink from example 1 by inkjet printer. After thermal annealing at 150° C. for 30 min, a specific resistivity of <12 μΩ·cm has been achieved.

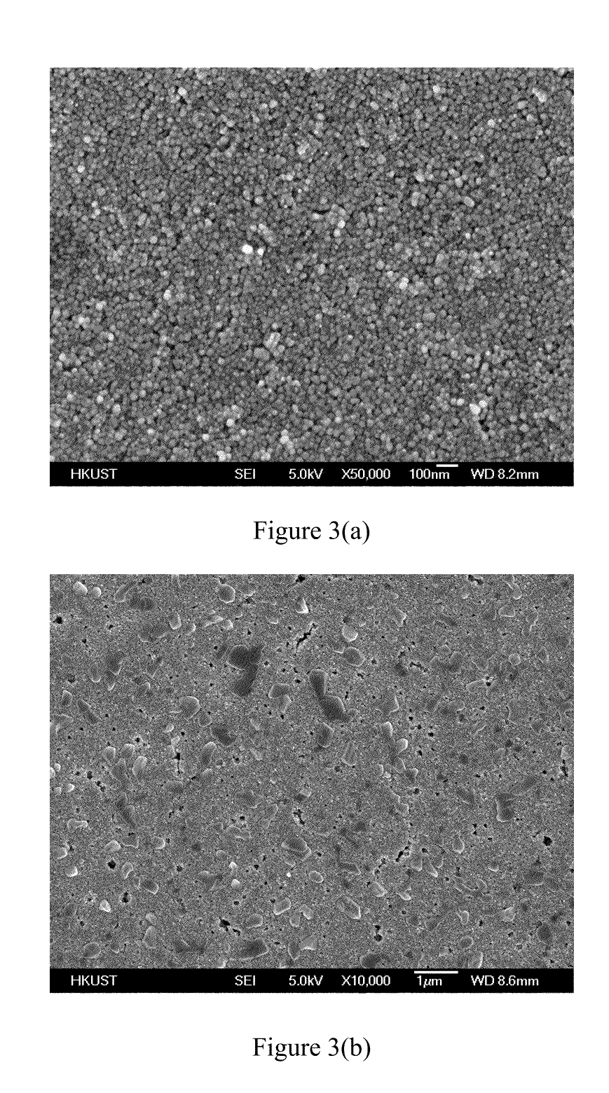

Referring now to FIG. 3, it can be seen from the SEM image that the grain size has been significantly increased (FIG. 3b) after annealing at 150° C. for 30 min compared with that in the deposited film (Fi. 3(a)), which indicates the formation of patterns with high conductivity. For instance, the grain size can reach to 0.5 μm-1.0 μm after sintering at 150° C.

The thickness of the resultant film is in the range of 0.75 μm-1.0 μm while the resistance ranges from 0.1-0.3 ohm/sq.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, the metal nanoparticles, contributing to the conductivity of the ink, may include, but not limited to gold, silver, copper, nickel, cobalt, zinc and other metals being electrically conductive. More than one type of metallic nanoparticles can be introduced into the ink. In the above embodiment of the present invention, the metal nanoparticles are silver nanoparticles, copper nanoparticles or combined copper and silver nanoparticles.

The dispersant may include, but not limited to BYK-108, BYK-110, BYK-180, BYK-190, BYK-333, provided by BYK Additives & Instruments, Germany. In one embodiment, the dispersant is BYK-190, an aqueous solution containing high molecular weight block copolymer.

The viscosity modifying solvent may include, but not limited to glycol-based compound such as ethylene glycol, diethylene glycol, triethylene glycol, glycerol, propylene glycol, polyethylene glycol, dipropylene glycol, triethylene glycol butyl ether and triethylene glycol methyl ether etc. In one embodiment of the invention, ethylene glycol and glycerol together are used to adjust the ink viscosity.

The surface tension adjusting solvent may include, but not limited to a hydrophilic solvent, such as water, methanol, ethanol, propanol, isopropanol, ethylene glycol, diethylene glycol, 1-butanol, 2-butanol, 2-methoxyethanol etc. The surface tension of the ink formulation should be adjusted between 30 and 40 dyen/cm.

The surface tension adjusting solvent is in the range of 30%-80% by weight percentage of the ink formulation, preferably in the range of 35%-60% or 55%-80%, or 70%-80%; the viscosity modifying solvent is in the range of 15%-50% by weight percentage of the ink formulation, preferably in the range of 15%-25% or 18%-33%, or 23%-28%; the dispersant is in the range of 0.5%-5% by weight percentage of the ink formulation, preferably 2.5%; the metal nanoparticle is in the range of 10%-40% by weight-volume percentage of the ink formulation, preferably 30%.

The metal precursor may include but not limited to metal chloride, metal nitrate, metal sulfate and metal acetate.

The controlled speed for adding metal solution into PVP solution depends on the characteristics of the metal precursors and the concentration thereof. It may be instantaneous, which means that the metal solution is poured in all together, or in the range of 1-10 ml/min, or 1-3 ml/min.

The reducing agent may include but not limited to sodium hypophosphate, ascorbic acid, sodium borohydride and hydrazine.

The sintering can be performed through a thermal oven or high energy flashing lamp.

The printer in the present invention can be a piezo-electrical inkjet or office-format printer.

The printed substrate may include, but not limited to standard office paper, photo paper, flexible thermoplastics, such as polyethylene terephthalate (PET), polybutylene terephthalate (PBT), polyethylene naphthalate (PEN), polypolyimide (PI) etc, and rigid substrate like glass slide.

Unless defined otherwise, all technical and scientific terms used herein have the same meaning as commonly understood by one of ordinary skill in the art to which this invention belongs. Although the description referred to particular embodiments, it will be clear to one skilled in the art that the present invention may be practiced with variation of these specific details. Hence this invention should not be construed as limited to the embodiments set forth herein.

The practice of the invention is exemplified in the non-limiting examples. The scope of the invention is defined solely by the appended claims, which are in no way limited by the content or scope of the examples.

What is claimed is:

1. An ink formulation, comprising
a) metal nanoparticles in the range of 10%-40% by weight-volume percentage of said ink formulation;
b) a dispersant in the range of 0.5%-5% by weight percentage of said ink formulation;
c) a viscosity modifying solvent in the range of 15%-50% by weight percentage of said ink formulation; and
d) a surface tension adjusting solvent in the range of 30%-80% by weight percentage of said ink formulation.

2. The ink formulation of claim 1, wherein the size of said metal nanoparticles is 20-30 nanometers.

3. The ink formulation of claim 1, wherein the viscosity of said ink composition is between 3-30 cPs, or 3-20 cPs.

4. The ink formulation of claim 1, wherein said metal nanoparticles are selected from a group consisting of silver, copper, gold, nickel, platinum, cobalt, zinc nanoparticles and a mixture thereof;
said dispersant is selected from a group consisting of BYK-108, BYK-110, BYK-180, BYK-190, and BYK-333;
said viscosity modifying solvent is selected from a group consisting of ethylene glycol, diethylene glycol, triethylene glycol, glycerol, propylene glycol, dipropylene glycol, triethylene glycol butyl ether, triethylene glycol methyl ether, and a mixture thereof; and
said surface tension adjusting solvent is selected from a group consisting of water, methanol, ethanol, propanol, isopropanol, ethylene glycol, diethylene glycol, 1-butanol, 2-butanol, and 2-methoxyethanol.

5. A method of forming a metal nanoparticle mixture, comprising,
a) dissolving PVP in glycol based solvent to obtain PVP solution;
b) dissolving metal precursor into a hydrophilic solvent to prepare metal salt solution;
c) adding said metal salt solution in step b) into said PVP solution in step a) with controlled speed to formulate a mixture; and
d) centrifuging said mixture in step c) and further washing to obtain said metal nanoparticle.

6. The method of claim 5, wherein said glycol based solvent in step a) is ethylene glycol, diethylene glycol, or polyethylene glycol;
said hydrophilic solvent in step b) is deionized water or ethylene glycol; and
said metal precursor in step b) is selected from a group consisting of metal chloride, metal nitrate, metal sulfate and metal acetate.

7. The method of claim 5, wherein the size of said metal nanoparticles is in the range of 20-30 nanometers.

8. The method of claim 5, wherein a reducing agent is further introduced before step c) into said PVP solution in step a), and said reducing agent is selected from a group consisting of sodium hypophosphate, ascorbic acid, sodium borohydride, and hydrazine.

9. A method of fabricating a conductive film comprising
a) forming an ink formulation of claim 1;
b) filtering said ink formulation in step a) and loading the filtered ink into a printer;
c) forming a film by printing said filtered ink on a substrate by pre-set printing parameters; and
d) sintering said film in step c) to obtain said conductive film;
wherein said sintering is conducted at a temperature not higher than 150° C.

10. The method of claim 9, the resistivity of said conductive film is less than 15 μΩ·cm, or less than 12 μΩ·cm.

11. The method of claim 9, wherein the thickness of said conductive film is in the range of 0.75 μm-1.0 μm.

12. The method of claim 9, wherein said substrate in step c) is selected from a group consisting of standard office paper, photo paper, polyethylene terephthalate, polybutylene terephthalate, polyethylene naphthalate, polypolyimide, and glass.

13. The method of claim 9, wherein said sintering is performed through a thermal oven or high energy flashing lamp.

14. The method of claim 9, wherein said printer is a piezo-electrical inkjet or office-format printer.
